(19) United States
(12) Patent Application Publication
(10) Pub. No.: US 2014/0025657 A1
(43) Pub. Date: Jan. 23, 2014

(54) AUTOMATED LANDING PAGE GENERATION AND PROMOTION FOR REAL ESTATE LISTINGS

(71) Applicant: Trulia, Inc., San Francisco, CA (US)

(72) Inventor: Ilya Dorfman, Oakland, CA (US)

(21) Appl. No.: 13/943,673

(22) Filed: Jul. 16, 2013

Related U.S. Application Data
(60) Provisional application No. 61/674,302, filed on Jul. 21, 2012.

(51) Int. Cl. G06F 17/30

(52) U.S. Cl. CPC G06F 17/3087; G06F 17/30241
USPC 707/711

(57) ABSTRACT

A system for automatic landing page creation comprises a processor configured to determine a set of popular search queries. The processor is configured to create, automatically, a landing page for each of the set of popular search queries.

### CROSS REFERENCE TO OTHER APPLICATIONS

This application claims priority to U.S. Provisional Patent Application No. 61/674,302 (Attorney Docket No. TRULP007+) entitled A METHOD, SOFTWARE SYSTEM AND DATA MODEL FOR AGGREGATING, STORING, DISTRIBUTING AND REPRESENTING REAL ESTATE DATA WITH AN ALGORITHM TO AUTOMATICALLY GENERATE INTERNET LANDING PAGES BASED ON FREQUENT USER-INITIATED SEARCH QUERIES filed Jul. 21, 2012 which is incorporated herein by reference for all purposes.

### BACKGROUND OF THE INVENTION

Website landing pages are not always easy for search engines or users to find for complex systems with databases. In particular, there are frequently requested searches that identify a subset of database information which is inconveniently dispersed on different landing pages.

### BRIEF DESCRIPTION OF THE DRAWINGS

Various embodiments of the invention are disclosed in the following detailed description and the accompanying drawings.

FIG. 1 is a block diagram illustrating an embodiment of a system for automatic landing page generation.

FIGS. 2A, 2B, and 2C are a flow diagrams illustrating embodiments of a process for automatic landing page generation.

FIG. 2D is a flow diagram illustrating an embodiment of a process for automatic landing page generation.

FIG. 3 is a flow diagram illustrating an embodiment of a process for automatic landing page generation.

FIG. 4 is a diagram illustrating embodiments of formats used for automatic generation of landing pages.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for automatic landing page creation is disclosed. The system comprises a processor configured to determine a set of popular search queries. The processor is configured to create, automatically, a landing page for each of the set of popular search queries. The system comprises a memory coupled to the processor and configured to provide the processor with instructions.

In some embodiments, creating the landing page comprises creating a uniform record locator. In some embodiments, the system comprises an interface configured to receive a query. In some embodiments, one search query of the set of popular search queries comprises a search query associated with a geographic area. In various embodiments, the geographic area comprises one of the following: a city, a state, a region, a neighborhood, a county, a province, a department, a district, or any other appropriate geographic area. In some embodiments, one search query of the set of popular search queries comprises a search query representing a group of search queries. In some embodiments, the group of search queries comprises a plurality of search queries with a value of an attribute within a range. In some embodiments, the range comprises one of a frequently requested set of ranges (e.g., a set of price ranges, a set of bedroom ranges, a set of bathroom ranges, a set of square footage ranges, etc.). In some embodiments, the set of ranges comprise a set of logarithmic ranges. In some embodiments, the attribute comprises a price. In various embodiments, the attribute comprises one of the following: bedrooms, bathrooms, square footage, floors, lot size, year built, or any other appropriate attribute. In various embodiments, the set of popular search queries comprises a top x % of most frequently occurring search queries, a top N of most frequently occurring search queries, or any other appropriate set of search queries. In some embodiments, the set of popular search queries are received in a period of time (e.g., an hour, a day, a week, a month, etc.).

The system for automatic uniform record locator provides a scheduled program that monitors frequently-requested user initiated search queries and automatically creates, stores, and indexes new URL's for all of or some of (e.g., a top percent, a top number, etc.) such queries. The system stores associations of URL's and query strings in a database (e.g., in a URL mapping table or a similar database table). A software application utilizing the system is able to serve unique landing pages associated with each frequently-requested search query in each geographic area (e.g., a city, a state, a region, a neighborhood, a county, a province, a department, a district, etc.).

In some embodiments, a scenario for grouping queries is as follows: assume there are 1000 users per day who are searching for 3 bedroom and 2 bathroom single family homes in San Jose. Of them, 500 search in combination with a price range between 500 k and 800 k, another 500 (partly overlapping with the first) specify that the lot size should be greater than 5000 square feet, and another partly overlapping 500 use a criterion that the living square footage should be at least 1200 square feet. There are many methods of determining a target group for this and other examples. In various embodiments, a grouping methodology comprises [LIST TWO or THREE methods], or any other appropriate manner of grouping search requests.

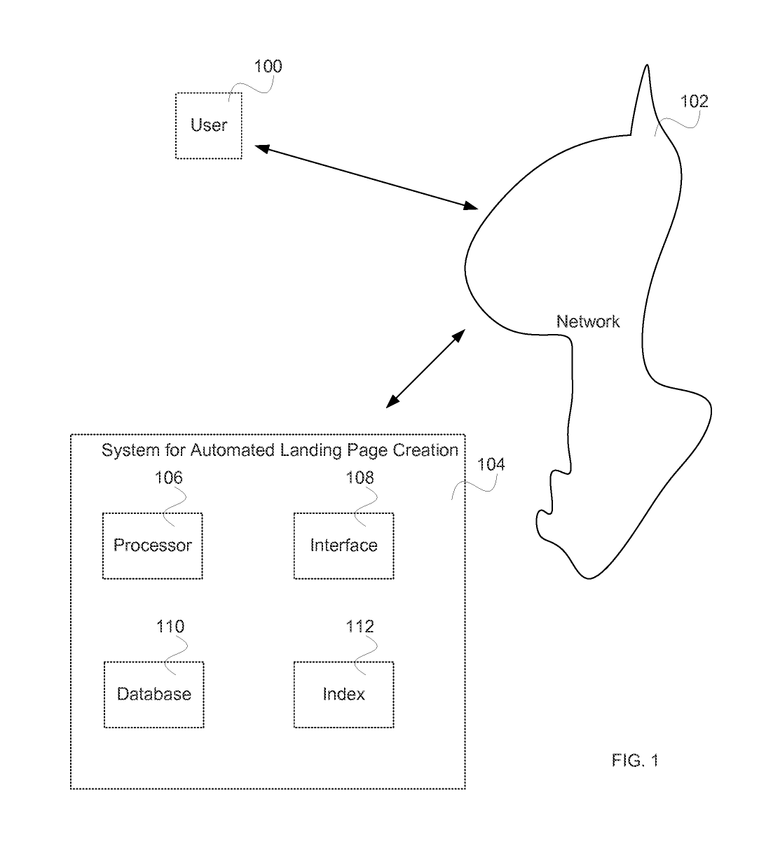

FIG. 1 is a block diagram illustrating an embodiment of a system for automatic landing page generation. In the example shown, user 100 interacts with system for automated landing page creation 104 via network 102. In various embodiments, network 102 comprises one or more of the following: a wired network, a wireless network, the internet, the World Wide Web, or any other appropriate network. User 100 requests a search by system for automated landing page creation 104—for example, a search of a real estate related database. System for automated landing page creation 104 comprises processor 106, interface 108, database 110, and index 112. Interface 108 receives search requests from a user (e.g., user 100). Processor 106 provides search results using index 112 from database 110 via interface 108 to user 100 in response to the search request. Processor 106 tracks search requests, groups search requests, tracks the number within each group of the search requests, and for a set of the groups of the search requests (e.g., the most frequently requested groups) create a custom landing page (e.g., a URL). The custom landing pages are stored in database 110 and indexed in index 112.

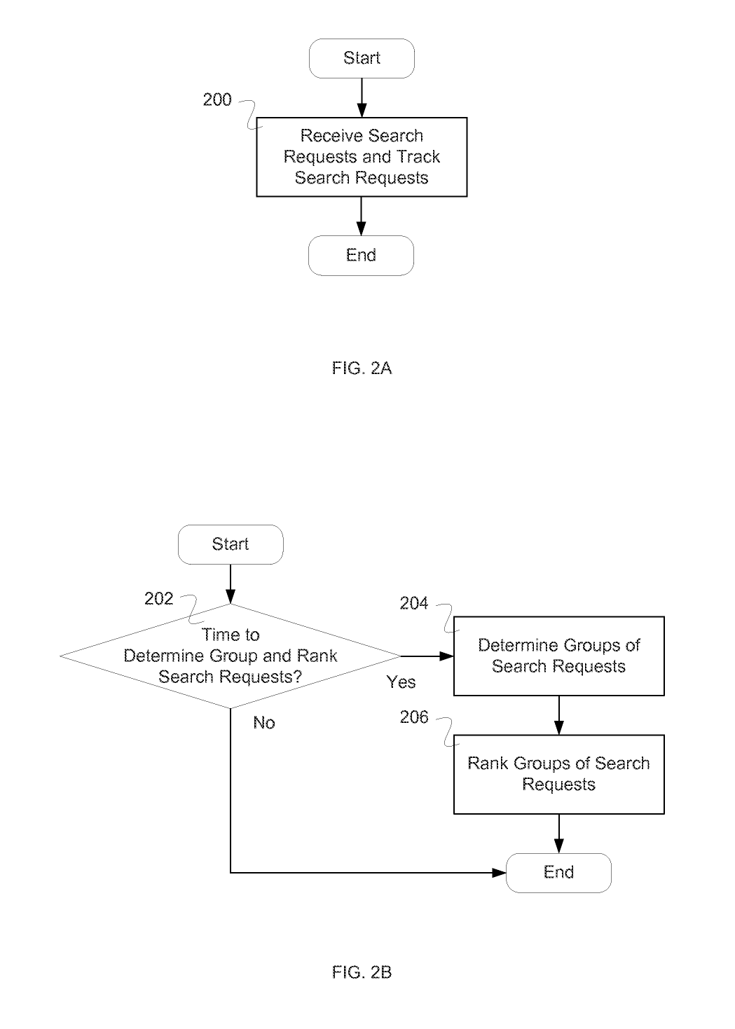

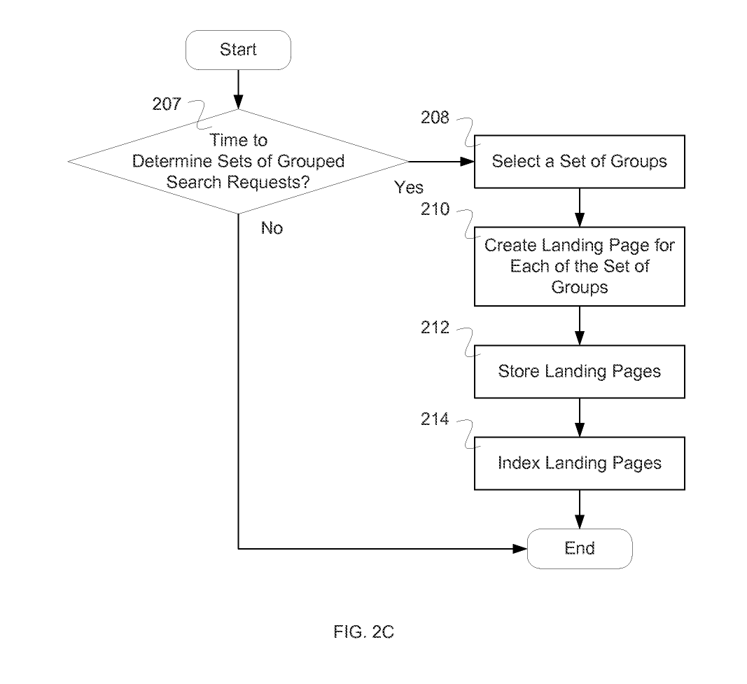

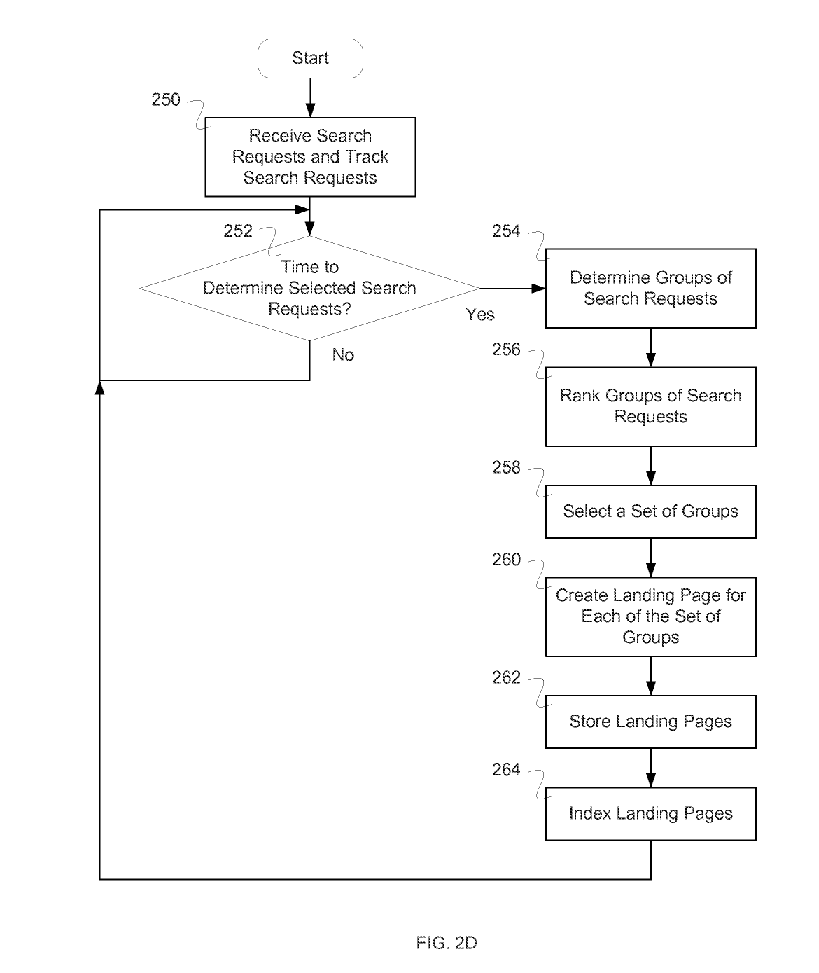

FIGS. 2A, 2B, and 2C are a flow diagrams illustrating embodiments of a process for automatic landing page generation. In some embodiments, the processes of FIGS. 2A, 2B, and 2C are executed using a processor (e.g., processor 106 of FIG. 1). In the example shown in FIG. 2A, in 200 search requests are received and tracked, and the process ends. For example, a search request to search a database using an index is receives. In some embodiments, a real estate database is searched by the user to identify a real estate listing (e.g., a home for sale, a home for rent, an apartment for rent, etc.).

In the example shown in FIG. 2B, in 202, it is determined whether it is time to determine group and rank search requests. For example, a schedule determines a time to group and rank search requests. In some embodiments, each of grouping and ranking are separate processes each with its own scheduler. In the event that it is not time to determine selected search requests, then the process ends. In some embodiments, control passes to 202 instead of ending. In the event that it is time to determine grouping and ranking search requests, in 204 groups of search requests are determined. For example, searches within a range of a value are grouped (e.g., searches for homes between 100 K and 200 K are grouped, between 200 K and 400 K are grouped, between 2-4 bedrooms are grouped, with more than 4 bathrooms are grouped, etc.). In 206, groups of search requests are ranked. For example, the number of search requests for a group of searches are used to stack rank the groups to determine a frequency of request (e.g., determining popularity).

In the example shown in FIG. 2C, in 207 it is determined whether it is time to select a set of grouped searches. For example, the process of selecting sets of groups and establishing landing pages for each of the sets is a separate scheduled process. In the event that it is time to select a set of grouped searches, in 208, a set of groups are selected. For example, a set of the groups is selected (e.g., top x % or top N groups, top 5%, 10%, 15%, 20%, top 5, 10, 15, 20 of the groups, etc.). In 210, a landing page is created for each of the set of groups. For example, a URL is created for each of the most frequently requested queries. In 212, the landing pages are stored. In 214, the landing pages are indexed and the process ends. In some embodiments, control passes to 207.

FIG. 2D is a flow diagram illustrating an embodiment of a process for automatic landing page generation. In some embodiments, the process of FIG. 2D is executed using a processor (e.g., processor 106 of FIG. 1). In the example shown, in 250 search requests are received and tracked. For example, a search request to search a database using an index is receives. In some embodiments, a real estate database is searched by the user to identify a real estate listing (e.g., a home for sale, a home for rent, an apartment for rent, etc.). In 252, it is determined whether it is time to determine selected search requests. In the event that it is not time to determine selected search requests, then control passes to 252. In the event that it is time to determine selected search requests, in 254 groups of search requests are determined. For example, searches within a range of a value are grouped (e.g., searches for homes between 100 K and 200 K are grouped, between 200 K and 400 K are grouped, between 2-4 bedrooms are grouped, with more than 4 bathrooms are grouped, etc.). In 256, groups of search requests are ranked. For example, the number of search requests for a group of searches is used to stack rank the groups to determine a frequency of request (e.g., determining popularity). In 258, a set of groups are selected. For example, a set of the groups is selected (e.g., top x % or top N groups, top 5%, 10%, 15%, 20%, top 5, 10, 15, 20 of the groups, etc.). In 260, landing page is created for each of the set of groups. For example, a URL is created for each of the most frequently requested queries. In 262, the landing pages are stored. In 264, the landing pages are indexed and control passes to 262.

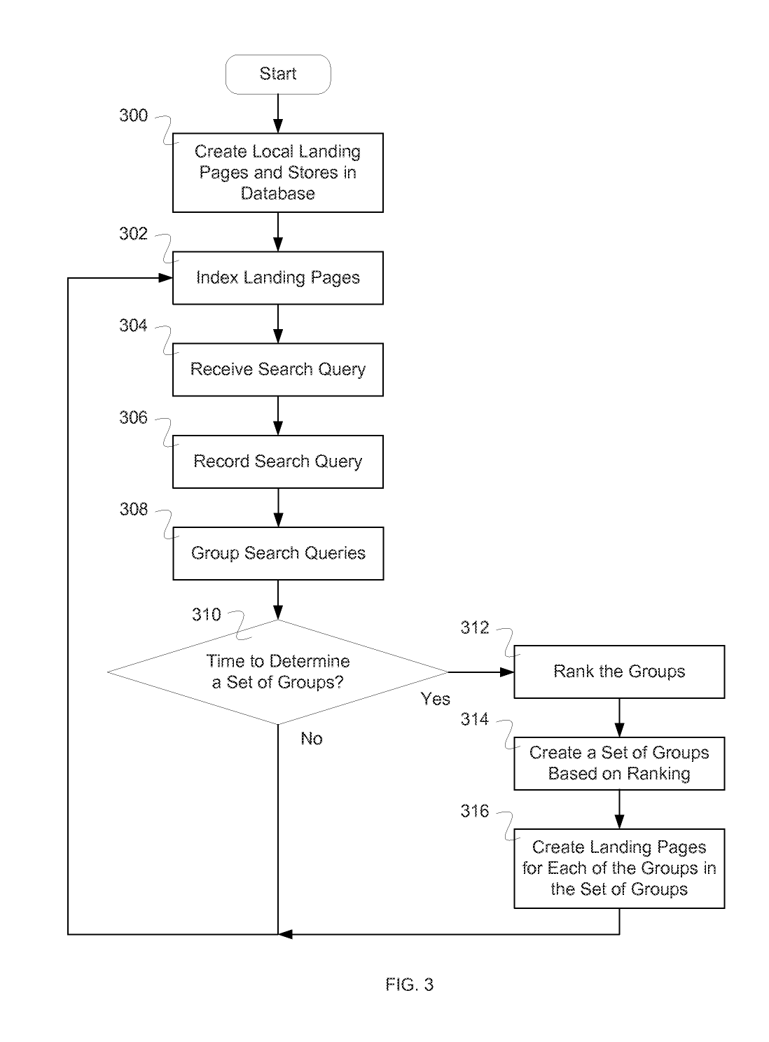

FIG. 3 is a flow diagram illustrating an embodiment of a process for automatic landing page generation. In some embodiments, the process of FIG. 3 is executed using a processor (e.g., processor 106 of FIG. 1). In the example shown, in 300 local landing pages are created and stored in a database. For example, landing pages are created and stored in a database. In some embodiments, the landing pages are related to a real estate listing (e.g., a home for sale, a home for rent, a home or apartment, etc.). In 302, the landing pages are indexed. For example, the landing pages are indexed and made available for search (e.g., a local search engine or a remote search engine—an internet search engine, etc.). In some embodiments, the index enables the landing pages to be located and found based on features and/or attributes associated with items in the landing pages. In various embodiments, landing pages are able to be located by a search engine using attributes and/or features associated with a real estate listing, where the feature or attribute comprises one or more of the following: number of bathrooms, number of bedrooms, square footage, lot footage, year built, price, or any other appropriate attribute or feature. In 304, a search query is received. For example, an attribute or a feature or a location area is received to search the database for a landing page. For example, a search query for a real estate listing is received to locate a property of interest based on a feature, an attribute, a location, or any other appropriate search criterion. In 306, the search query is recorded. For example, the search query is recorded in a database including the query, the date, the origin (e.g., user information, computer information, browser information, etc.), metadata associated with the query, etc. In 308, the search queries are grouped. For example, queries that are alike are grouped for rankings or frequency determinations. For example, queries for a given city are grouped if the price attribute is within a given range. For example, queries for a neighborhood are grouped if the number of bedrooms is within a given range. In 310, it is determined whether it is time to determine a set of groups. In the event that it is time to determine a set of groups, in 312 the groups are ranked. For example, the query groups are ranked from the most frequently or often received to least frequent or often received. In 314, a set of groups is created based on the ranking For example, the top x % of the groups are placed in the set. For example, the top N of the groups are placed in the set. In various embodiments, the time to determine the set of groups is periodic (e.g., every day, every week, every two weeks, every month, every hour, etc.) or based on a number of queries (e.g., every 10^{th} query, every 100^{th} query, every 200 queries, every 1000^{th} query, etc.), or any other appropriate time. In 316, a landing page is created or generated for each of the groups in the set of groups and control passes to 302. For example, each of the query groups has a landing page generated for the query group (e.g., a page is generated for the search queries for homes of $200 K-$400 K in Phoenix, Ariz.—an attribute in a range in a location). In the event that it is not the time to determine the set of groups, control passes to 302.

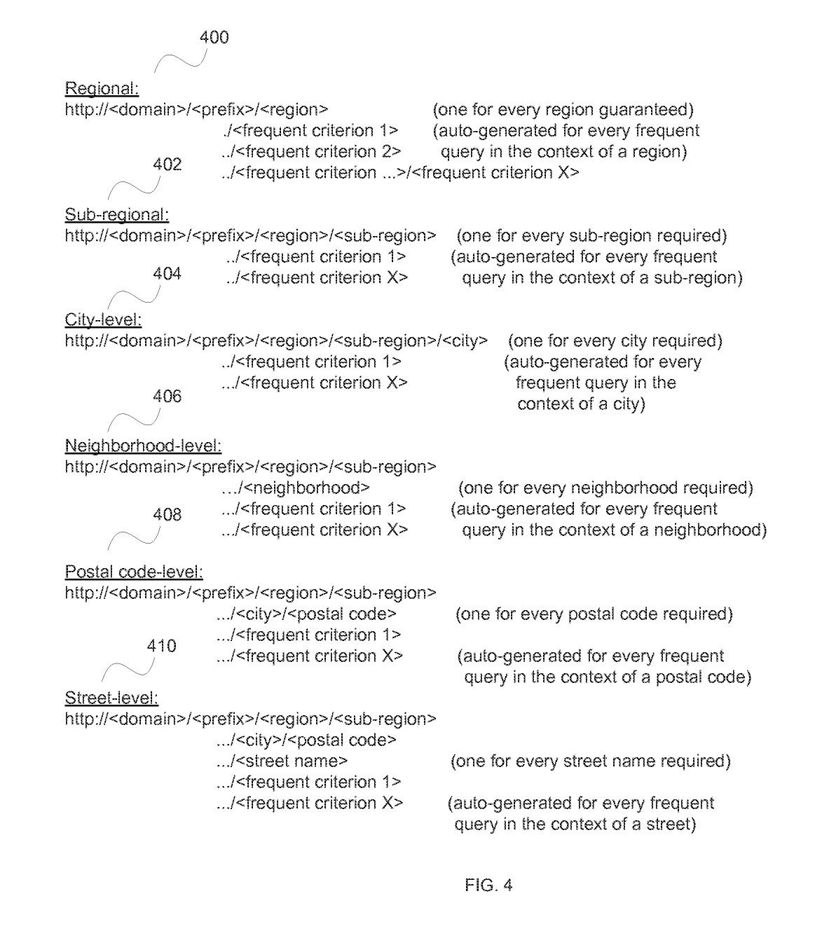

FIG. 4 is a diagram illustrating embodiments of formats used for automatic generation of landing pages. In the examples shown, an example format is expressed for an automatically generated landing page. In 400, a regional format is expressed. The regional format is used to generate a landing page for every frequent query in the context of a region. For example, the landing page URL would include a field for a domain (e.g., a company name), for a prefix (e.g., homes for sale, homes for rent, apartments for sale, apartments for rent, land for sale, etc.), for a region, for a frequent criteria 1, for a frequent criteria 2 (if appropriate), . . . , and for a frequent criteria X (if appropriate). A specific example is:

http://CompanyName/HomesForSale/WineCountry/3Bedrooms/Price-200K-to-300K/

In 402, a sub-regional format is expressed. The sub-regional format is used to generate a landing page for every frequent query in the context of a sub-region. For example, the landing page URL would include a field for a domain (e.g., a company name), for a prefix (e.g., homes for sale, homes for rent, apartments for sale, apartments for rent, land for sale, etc.), for a region, for a sub-region, for a frequent criteria 1, . . . , and for a frequent criteria X (if appropriate). A specific example is:

http://CompanyName/HomesForSale/SouthBay/EasternSide/2Bathrooms/Price-700K-to-800K/

In some embodiments, the frequent criteria or criterion comprises a parameter (e.g., bathrooms or Price), a range for a value (e.g., 700 K to 800 K), or a fixed value (e.g., 2).

In 404, a city-level format is expressed. The city-level format is used to generate a landing page for every frequent query in the context of a city. For example, the landing page URL would include a field for a domain (e.g., a company name), for a prefix (e.g., homes for sale, homes for rent, apartments for sale, apartments for rent, land for sale, etc.), for a region (if appropriate), for a sub-region (if appropriate), for a city, for a frequent criteria 1, . . . , and for a frequent criteria X (if appropriate). A specific example is:

http://CompanyName/HomesForSale/EastBay/Oakland/SqFt-2000-to-3000/Price-500K-to-625K/
where the sub-region has been omitted. In some embodiments, a sub-region could be included (e.g., AlamedaCounty in the above example). In some embodiments, the frequent criteria or criterion comprises a parameter (e.g., square footage or Price) and a range for a value (e.g., 500 K to 625 K or 2000 to 3000).

In 406, a neighborhood-level format is expressed. The neighborhood -level format is used to generate a landing page for every frequent query in the context of a neighborhood. For example, the landing page URL would include a field for a domain (e.g., a company name), for a prefix (e.g., homes for sale, homes for rent, apartments for sale, apartments for rent, land for sale, etc.), for a region (if appropriate), for a sub-region (if appropriate), for a city, for a neighborhood, for a frequent criteria 1, . . . , and for a frequent criteria X (if appropriate). A specific example is:

http://CompanyName/HomesForSale/Oakland/TrestleGlen/Levels-2/Bathrooms1.5/
where the region and sub-region have been omitted. In some embodiments, a region and/or a sub-region could be included (e.g., EastBay and/or AlamedaCounty in the above example). In some embodiments, the frequent criteria or criterion comprises a parameter (e.g., levels or number of bathrooms) and a fixed value (e.g., 2 or 1.5).

In 408, a postal code-level format is expressed. The postal code-level format is used to generate a landing page for every frequent query in the context of a postal code. For example, the landing page URL would include a field for a domain (e.g., a company name), for a prefix (e.g., homes for sale, homes for rent, apartments for sale, apartments for rent, land for sale, etc.), for a region (if appropriate), for a sub-region (if appropriate), for a city, for a neighborhood, for a postal code, for a frequent criteria 1, . . . , and for a frequent criteria X (if appropriate). A specific example is:

http://CompanyName/HomesForSale/Sanfrancisco/Sunset/94122/GarageNo/FullBasementYes/
where the region and sub-region have been omitted. In some embodiments, a region and/or a sub-region could be included (e.g., BayArea and/or Peninsula in the above example). In some embodiments, the frequent criteria or criterion comprises a parameter (e.g., garage or full basement) and a binary indicator (e.g., No or Yes).

In 410, a street-level format is expressed. The street-level format is used to generate a landing page for every frequent query in the context of a street. For example, the landing page URL would include a field for a domain (e.g., a company name), for a prefix (e.g., homes for sale, homes for rent, apartments for sale, apartments for rent, land for sale, etc.), for a region (if appropriate), for a sub-region (if appropriate), for a city, for a neighborhood, for a postal code, for a frequent criteria 1, . . . , and for a frequent criteria X (if appropriate). A specific example is:

http://CompanyName/ApartmentForRent/Sanfrancisco/Tenderloin/94109/Geary/Floor.GT.3/
where the region and sub-region have been omitted. In some embodiments, a region and/or a sub-region could be included (e.g., BayArea and/or Peninsula in the above example). In some embodiments, the frequent criteria or criterion comprises a parameter (e.g., Floor) and a logical or mathematical expression (e.g., greater than 3).

In some embodiments—when the System detects that a feature combination is frequently requested in a city (e.g., the feature combination of 3 bedrooms with 2 bathrooms for a single family homes in a city of Carmel, Calif.), the system generates a new landing page with a URL in the following format: http://<domain>/<prefix>/<state>/<city>/feature1/feature2 (e.g., http ://realestatesite/top/ca/carmel/singlefamilyhome/3bedroom/2bathroom).

In some embodiments, frequency is defined by an application developer (e.g., a query that is in the top X % of most requested user search queries in a given geography is considered frequent, where X is defined by an application and is, for example, 2%, 22%, 48%, 10%, etc.). When the System detects frequent querying based on a continuous attribute, such as price, a statistical approximation will be applied to determine most frequently requested ranges (e.g., in a simplistic example all price 5 queries in a single geographic area may be grouped into ranges 0 to 100 k, 100 k to 200 k, 200 k to 400 k, etc . . , and a range with most requested queries is then chosen by the System for creation of a unique landing page). In various embodiments, the ranges have constant spacing, increasing spacing, logarithmic spacing, geometric spacing, predetermined spacing, regular spacing, irregular spacing, or any other appropriate spacing.

In some embodiments, consumers or users reach dynamically-generated landing pages by searching for relevant content through one of generally available search engines and clicking in results provided by a search engine (e.g., a generalized web search engine, a specific web site search engine, a proprietary search engine on a private database, etc.).

In some embodiments, when requested through a browser, landing pages are automatically retrieved from the database listings using associated search query strings, which are mapped to landing page URL's (e.g., in a URL mapping table). An application designer may optionally add custom human-created content, images, media or advertising, and associate said additional content with landing page URL's (in a URL MAPPING table). Automatic landing pages would then include additional user-generated content and display it along with listings in the results. Local businesses, establishments and organizations may utilize Local Landing Pages provided by the System to publish ads targeting a particular consumer demographic niche (e.g. expensive cars ads on a dynamic landing page, which corresponds with luxury listings in Cape Cod, Mass.), or provide relevant information for consumers in any available demography and geography. The System allows an application to place links to said dynamically-generated landing pages on a website based on hierarchical categories (e.g. links to all landing pages in Santa Cruz, Calif.).

In some embodiments, the System allows application designers to create additional custom landing page URL's and associate them with any search query strings manually (e.g., in a URL mapping table). Suppose an entry is created in the URL mapping table which defines a new landing page URL and associates it with a desired query string. For example if application designer maps the following URL:

“http://<domain>/<prefix>/most-expensive”
to the following query string:

“from=7000000&propertytype=Detached” then the System insures that all Detached homes priced above $7 million are retrieved when such a URL is requested by a browser or a search engine crawler.

In some embodiments, if a custom content file (e.g. an XML file with custom content, ads and/or references to image files) is mapped to such a URL in the URL mapping table then the System will include content and advertisements contained in that file when rendering the “http://<domain>/<prefix>/most-expensive” page.

In some embodiments, the system organizes all housing, land and other real estate listings in geographic categories and provides a way to associate file names of custom pages, containing custom local content, with automatically-generated URL's representing each geographic place. Search engine crawlers will be able to traverse such tree hierarchy of the stored data and/or use a generated index or a stored system index for a valid landing page at every node pointing to a geographic place. For example, a street level search engine-friendly geographic URL has the following format:

http://<domain>/<prefix>/<region>/<sub-region>/<city>/<postal code>/<street name>

In some embodiments, each street, road or highway with real estate listings in the System's database has a corresponding geographic URL in the described above format. Once a user calls such a URL the corresponding landing page retrieves real estate listings located on that street and any custom-written street-level content or ads associated with that street, if appropriate.

In some embodiments, any or all local pages or landing pages may be offered as online or mobile advertising boards to local businesses where they may advertise their services or products side by side with relevant housing listings that are displayed on those pages by the System. The System may be augmented with a specialized classified ads service (with an accompanying online ads manager application) for local businesses and local organizations to choose between System's landing pages with regard to where to advertise their services or products to target a desired specific audience. As an example, local general contractors may choose to advertise their services on landing pages, which correspond with fixerupper homes in their area of service (e.g. http://<domain>/<prefix>/ny/suffolk/smithtown/fixer-uppers).

In some embodiments, a landing page is created for a new subdivision or apartment building. For example, a new building is erected with a few hundred new condo units, which receives a lot of attention in the community. One or more landing pages would then get created for such a building. In some cases, pages would get created related to the subdivision or building in combination with other relevant popular criteria. As an example, a landing page:

### ./New-construction/Luxury/123-Geary-street/is

created.

In some embodiments, landing pages for popular queries serve as a platform for marketing and content developers to promote listings on those pages organically. For example, suppose that the processor (e.g., in steps 210 or 316) determines that new construction condos in Redwood City are particularly popular, and hence a landing page is automatically created to promote those listings. Upon creation of such new landing pages, a notification is sent to content developers and marketers to start adding content and linking to those landing pages. The system therefore serves as a notifier helping optimize content development and marketing activities. Crawlers (e.g., Google) will then “notice” relevant human-generated content and will promote those new pages just as crawler sites help themselves provide relevant organic content to its users. The end effect is that users—who are searching directly on Google, Yahoo or Bing and who have similar preferences to those who are already using Trulia directly (when submitting their “popular” queries)—will receive Trulia landing pages in their organic search queries more frequently. This will increase legitimately overall organic traffic to the system's site.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for automatic landing page creation, comprising:
a processor configured to:
determine a set of popular search queries;
create, automatically, a landing page for each of the set of popular search queries; and
a memory coupled to the processor and configured to provide the processor with instructions.

2. A system as in claim 1, wherein one search query of the set of popular search queries comprises a search query associated with a geographic area.

3. A system as in claim 2, wherein the geographic area comprises one of the following: a city, a state, a region, a neighborhood, a county, a province, a department, or a district.

4. A system as in claim 1, wherein one search query of the set of popular search queries comprises a search query representing a group of search queries.

5. A system as in claim 4, wherein the group of search queries comprises a plurality of search queries with a value of an attribute within a range.

6. A system as in claim 5, wherein the range comprises one of a frequently requested set of ranges.

7. A system as in claim 6, wherein the set of ranges comprise a set of logarithmic ranges.

8. A system as in claim 5, wherein the attribute comprises a price.

9. A system as in claim 5, wherein the attribute comprises one of the following: bedrooms, bathrooms, square footage, floors, year built, or lot size.

10. A system as in claim 1, wherein the set of popular search queries comprises a top x % of most frequently occurring search queries.

11. A system as in claim 1, wherein the set of popular search queries comprises a top N of most frequently occurring search queries.

12. A system as in claim 1, wherein the set of popular search queries are received in a time period.

13. A system as in claim 12, wherein the time period comprises one of the following: an hour, a day, a week, or a month.

14. A system as in claim 1, wherein the processor is further configured to store the URL.

15. A system as in claim 1, wherein the processor is further configured to add an entry for the URL in an index.

16. A method of automatic URL creation, comprising:
determining, using a processor, a set of popular search queries; and
creating, automatically, a URL for each of the set of popular search queries.

17. A method as in claim 16, wherein one search query of the set of popular search queries comprises a search query representing a group of search queries.

18. A method as in claim 17, wherein the group of search queries comprises a plurality of search queries with a value of an attribute within a range.

19. A computer program product for automatic URL creation, the computer program product being embodied in a tangible computer readable storage medium and comprising computer instructions for:
determining a set of popular search queries; and
creating, automatically, a URL for each of the set of popular search queries.

20. A computer program product recited in claim 19, wherein one search query of the set of popular search queries comprises a search query representing a group of search queries.

21. A computer program product recited in claim 20, wherein the group of search queries comprises a plurality of search queries with a value of an attribute within a range.
